(19) United States
(12) Patent Application Publication
(10) Pub. No.: US 2010/0165655 A1
(43) Pub. Date: Jul. 1, 2010

(54) Energy saving illumination system

(76) Inventor: Nicholas Alcov, Arroyo Grande, CA (US)

Correspondence Address: Nicholas Alcov, 2398 Callender Rd., Arroyo Grande, CA, 93420, US

(21) Appl. No.: 12/317,678

(22) Filed: Dec. 29, 2008

(51) Int. Cl. F21V 8/00; F21V 99/00; F21V 7/00

(52) U.S. Cl. 362/551; 362/458; 362/317

(57) ABSTRACT

Disclosed is an energy saving illumination system. The energy saving illumination system comprising an energy source, preferably renewable, a means of illumination, a non energy requiring means of enhancing said illumination, a means of conducting said illumination, and an additional means of illumination not requiring additional commercial energy thereby creating an illumination system while providing energy savings over traditional means.

### FIELD OF THE INVENTION

The present invention relates to an illuminating system and more specifically to an energy saving illuminating system.

### BACKGROUND OF THE INVENTION

Generally, illumination for homes, offices, stores etc, has been supplied by a relatively small object such as a light bulb used to illuminate a large area such as a room. Backsplashes, footboards, doorjambs and the like have been utilized in kitchens and bathrooms, in rooms of homes, offices and buildings. Generally ceramic tile, wood or similar material has been utilized. These have been used to serve as a seal between surfaces and a protective barrier against water splashes as in the case of backsplashes and against impact and abrasion, as in the case of footboards and door jambs. Short of the efforts to move away from traditional incandescent light bulbs, very little has been done to save energy in the way that we illuminate homes and offices.

What is needed is a material which would provide the uses mentioned above and would additionally provide illumination and do so in such a manner as to conserve the amount of energy traditionally used to illuminate a room and to accomplish this in an esthetically pleasing manner. Generally, illumination may be required for various needs and at various times. For illustration purposes, discussion is focused on a home. But similar principles apply to an office, store, warehouse etc. For example when someone is in a room, a different degree of illumination is required than when no one is in the room. A different degree of illumination is required in the evening than at night when every one is asleep. In addition the amount of illumination would vary depending on the purpose. For example a different degree of illumination is require for reading than to transverse from one room to the next.

Generally there is no need for illumination if no one is in a room. We usually leave lights on to aid in moving from room to room. By using motion sensors the energy saving illumination system would save energy by providing illumination when someone enters an area. For those instances when no one is in the room and illumination is required, this system provides a low energy ambient light. It is an excellent means of providing illumination when one traverses from one room to the next and for when everyone is asleep. In addition, lighting frequently tends to be very bright or non existent. The use of energy is greatest at the initial period when lights are first turned on. The energy saving illumination system would provide an alternative to the traditional incandescent bulb and reduce the many repeated times when an unnecessarily bright light is turned on for a brief period of time. By illuminating a doorjamb for example, the need to turn on a bright light just to locate the doorknob may be eliminated or reduced thereby saving energy. This is especially true if a renewable source of energy is utilized as an alternative means of energy to provide the illumination.

Developments have been made in illuminated materials The prior art related to the developments include the following:

Trudeau, Lauziere application Ser. No. 10/217,473 details an illuminating structure.

Mueller, Lys et, al, U.S. Pat. No. 7,358,929 describes a lighting system in which LED are imbedded within a tile, but there is no mention of enhancing the illumination or attempting to provide an energy savings.

While LED lights embedded in tiles are available, there has been little effort to provide an alternative to the light bulb as a means of illumination. Accordingly there remains a need for an energy saving illuminating system.

### SUMMARY OF THE INVENTION

In view of forgoing disadvantages inherent in the prior arts, the general purpose of the present invention is to provide an illumination system designed to save energy, configured to include the advantages of the prior art, and to overcome the disadvantages of the prior art.

The present invention provides an energy saving illuminating system such that a source of illumination is enhanced and such that alternate sources of illumination may be reduced or eliminated and provide this preferably in an esthetically pleasing manner. The energy saving illuminating system provides a source of illumination, the power for which is preferably renewable, a means of enhancing the illumination, a means of conducting the illumination to a location where the illumination can be further enhanced. The illumination may additionally pass through a material which will continue to phosphoresce once the power and energy source are shut off.

Since the initial light source is being enhanced, conducted and phosphoresced, the power for which is provided preferably by a renewable means, the amount of energy required to create a similar amount of light without using the energy saving illumination system would be greater. Thus an energy savings would be created using this invention while an esthetically pleasant appearance is achieved.

The energy saving illumination system can serve as an ambient lighting thereby reducing the need to leave lights on during the night or to turn on brighter lights to illuminate the path.

This material can be utilized in floor and ceiling molding, kitchen and bathroom backsplashes, door jambs, fireplace surrounds, banisters, floors and ceilings, wall art as well as other uses.

These together with other aspects of the present invention, along with various features of novelty that characterize the invention, are pointed out with particularity in the claims annexed hereto and forming a part of the disclosure. For a better understanding of the invention, its operating advantages and its specific objects attained by its uses, reference should be had to the accompanying drawings and descriptive matter in which therein are illustrated exemplary embodiments of the present invention.

### BRIEF DESCRIPTION OF THE DRAWINGS

The advantages and features of the present invention will become better understood with reference to the following more detailed description and claims taken in conjunction with the accompanying drawings wherein like elements are identified with symbols, and in which:

FIG. 1 is a side exploded view of an energy saving illumination system according to an exemplary embodiment of the present invention.

FIG. 2 is a side view of an energy saving illumination system according to an exemplary embodiment of the present invention.

FIG. 3 is a front exploded view of an energy saving illumination system according to an exemplary embodiment of the present invention.

FIG. 4 is a side exploded view of an energy saving illumination system according to an exemplary embodiment of the present invention.

FIG. 5 is a front exploded view of an energy saving illumination system according to an exemplary embodiment of the present invention.

FIG. 6 is a front exploded view of an energy saving illumination system according to an exemplary embodiment of the present invention.

FIG. 7 is an exploded front perspective view of an energy saving illumination system according to an exemplary embodiment of the present invention.

Like reference numerals refer to like parts throughout the description of several views of the drawings.

### DETAILED DESCRIPTION OF THE INVENTION

The detailed embodiments described herein detail for illustrative purposes are subject to many variation in structure and design. It should be emphasized however that the present invention is not limited to a particular energy saving illuminating system as shown and described. It is understood that various omissions, substitutions of equivalents are contemplated as circumstances may suggest or render expedient, but is to cover the application or implementation without departing from the spirit or scope of the claims of the present invention.

The terms “first”, “second”, and the like, herein, do not denote any order, quantity, or importance, but rather, are used to distinguish one element from another, and the terms “a”, and “an”, herein do not denote a limitation of quantity, but rather denote the presence of at lease one of the referenced items.

In one aspect of the present invention, the energy saving illuminating system 100 contains a means of illumination. The illumination from a light source 101 or plurality of light sources is placed in a position or positions such that the emitted light can be enhanced by a means which preferably does not require the additional expenditure of costly energy. An example of, but not limited to, such a means of illumination may be a ribbon of LED lights 106.

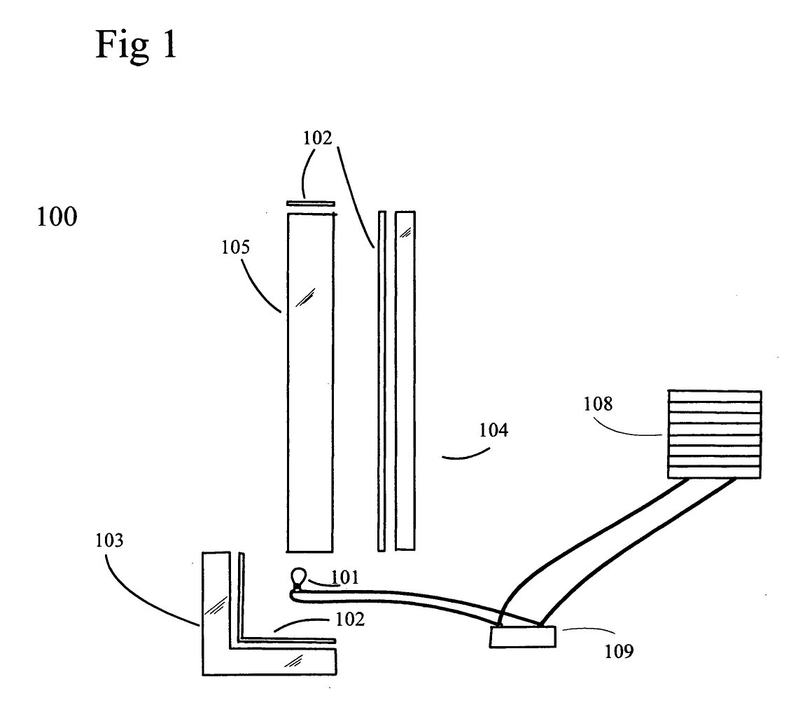

The energy required to illuminate the light source can be provided by a variety of means, preferably renewable, such as but not limited to energy from solar, wind, and/or etc. FIG. 1 illustrates a solar panel 108 connected to a rechargeable battery 109 which stores the power until needed, to illuminate a light source 101. The rechargeable battery, solar panel, LED ribbon are readily available at various retailers and electronic supply stores. An energy source, preferable renewable, provided by means such as wind, solar and/or etc placed outdoors would need to have that energy routed to the illumination source which may be positioned in a different location such as indoors. Such means are readily available in the form of electrical wiring. Fuel cells such as direct methanol fuel cells DMFC can provide low amounts of power for long periods of time which is ideal for the energy saving illumination system. Although currently cost prohibitive, prices are expected to drop as technology improves and these may serve as another means of providing a useful power source which does not have to be outdoors as in the case of solar and wind.

An enhancement source to increase the illumination can be provided by various means such as, but not limited to reflection and, or magnification as well as other means. In FIG. 1 the light source 101 is positioned between a reflective material 102 and a structural material such as a backsplash, footboard, door jamb etc. Examples of a reflective material include but are not limited to a mirror, reflective foil, polished metal, etc. The reflective material 102 would be held in position to maximize the enhancement of the light source by a variety of means such as but not limited to glue, tape, screws and, or etc. One example of positioning the reflective material 102 is adhering it onto a decorative molding 103, onto the backing 104, and to the top of the structural material which for this example will be a tile 105, by means such as, but not limited to, glue, tape, screws and or other such means.

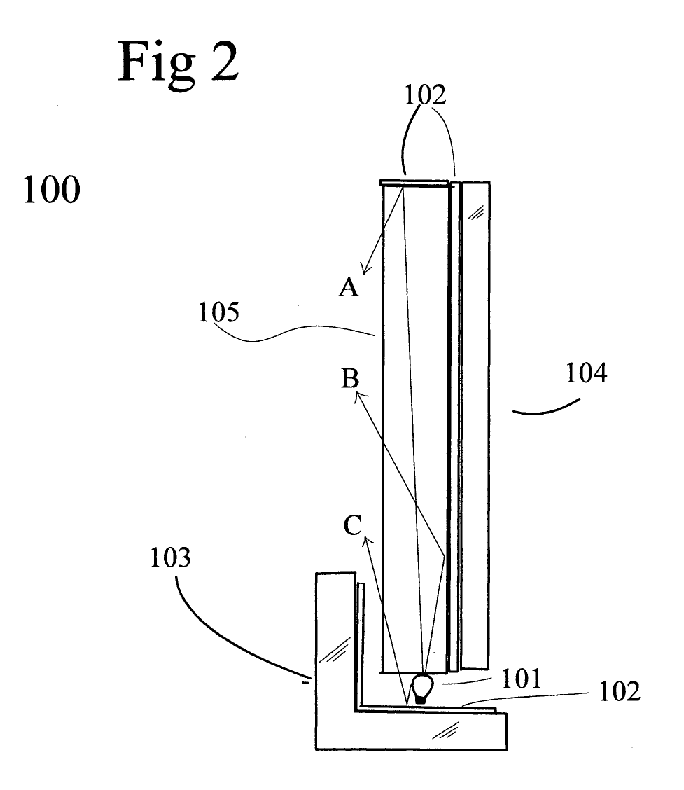

For illustrative purposes, a translucent or transparent structural material such as a tile 105 for a kitchen backsplash will illustrate that although light will pass out through the face or front of the tile, some will pass up through the tile and be reflected off of the reflective material at the top of the tile. In addition some of the illumination will be reflected off of the reflective material 102 at the bottom, and off of the reflective material on the backing 104, thus enhancing the original degree of illumination. A decorative molding similar to the one at the bottom can also be utilized to position the reflective material to the top of the tile (not shown). The reflective material at the top of the tile, would reflect the illumination in a downward direction and also against the reflective material 102 on the backing 104. The reflective materials would be positioned such that the reflection of the light source would be maximized. Reflection from outside sources such as light coming through windows as well as others sources, would also be reflected and incorporated into the illumination being generated by the energy saving illuminating system. The illumination from a light source 101 acting on the reflective material 102 of the molding 103, the backing 104 and the top of the tile 105 would cause some of the light rays to also be reflected onto the reflective material on the backing 104 thus enhancing the illumination. In FIG. 2 the light paths shown by arrows A, B, C are just some of the multitude of paths that the light could take. The light would pass through a surface. We are all familiar with the reflection of light off of mirrored surfaces, so there is no need for further examples.

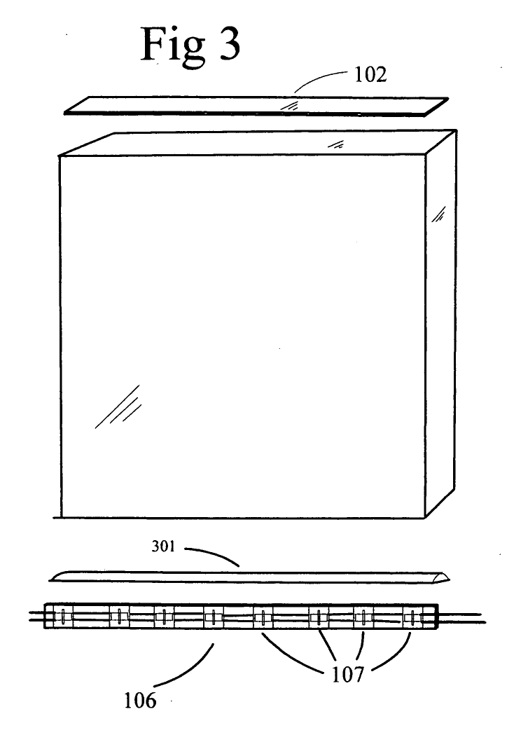

Another means of increasing illumination would be by magnification. FIG. 3 illustrates an example where the illumination is provided by means of LED lights 107 in a LED ribbon 106. The enhancement of the illumination is provided by means of a magnifying rod 301. The magnified light is directed upward through the tile. Reflective material 102 on top of the tile 105, reflects the illumination back through the tile again. Reflective material on the backing (not shown would also reflect the illumination back through the tile. Once again the tile in these examples are composed of transparent or translucent material such as glass, resin, plastic etc.

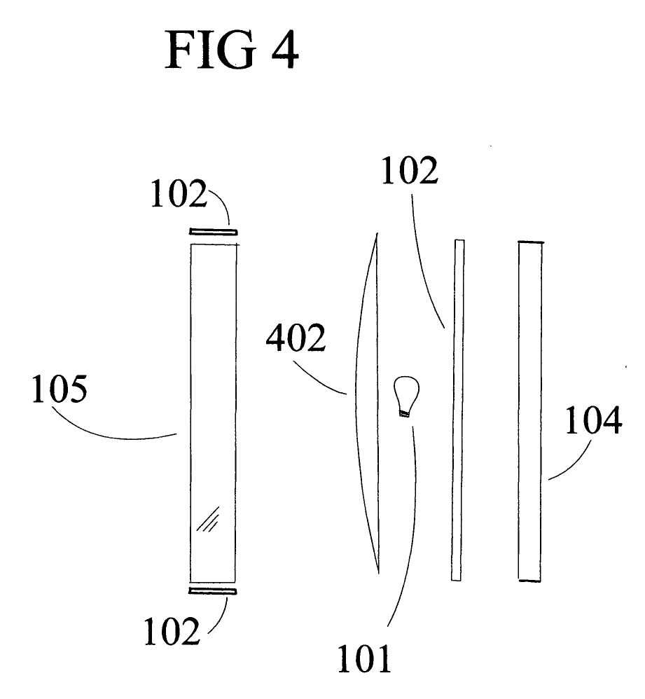

FIG. 4 illustrates an example of magnification in front of the light source 101, the illumination from which is enhanced by a magnifier 402 positioned in front of the light source 101. Reflective material 102 which adheres to the backing 104 and the top and bottom of the tile 105 further enhances the illumination as it passes through the tile.

While the example of the enhancement sources cited direct the illumination back through the surface, other possibilities are anticipated, such as directing some and/or all of the illumination out into the room. Another choice would be to direct some and/or all of the illumination up toward the ceiling as another means of illuminating the area.

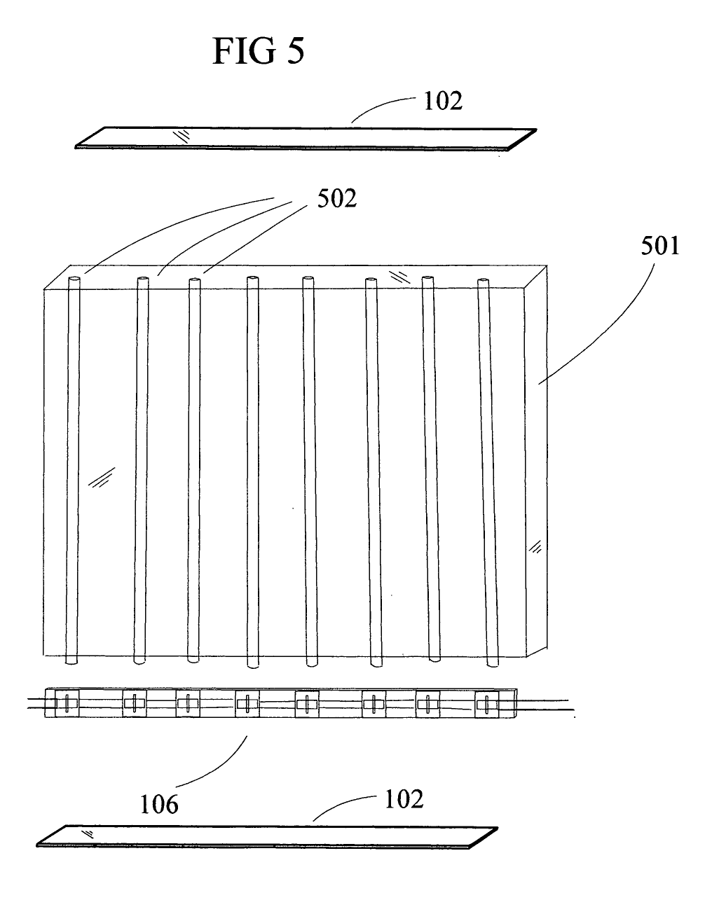

Running through the tile 501 are a means of conducting the light from the source or sources through out the tile to the illumination enhancing material at another location. These conducting sources 402 are particularly beneficial in that there may be decorative objects 403 within the tile which would obstruct the light path from reaching the other illumination enhancing sources. Means of conduction may be, but not limited to, fiber optic strands, mirrors, glass and/or etc. In an example, fiber optic strands are designed to generally illuminate the light either at the ends or at the sides of the fiber optic strand. A means of focusing the light onto the end of the fiber optic strands may be needed to reduce light loss. In the example of the LED ribbon, each of the fiber optic cables would be positioned over a LED as illustrated in FIG. 5. One such means of focusing the light is with the use of illuminators (not shown) which are available at most suppliers of fiber optic cables. FIG. 5 illustrates one example of the conducting strands 502 running in a parallel fashion. These conducting strands reduce the degree of loss and direct the illumination to the illumination enhancing material 102. The conductive strands further aid in conducting illumination when the composition of the tile is such that it would block the illumination. These conducting sources 402 would preferable be positioned such that the illumination is visible at the face of the tile so that it is beneficial in illuminating the room. Some means of accomplishing this are positioning the strands within the tile but close enough to the face of the tile that the illumination is visible. Another means would be to adhere the conducting strands to the outside face of the tile. The conducting strands may be arranged to create a pleasant decorative appearance.

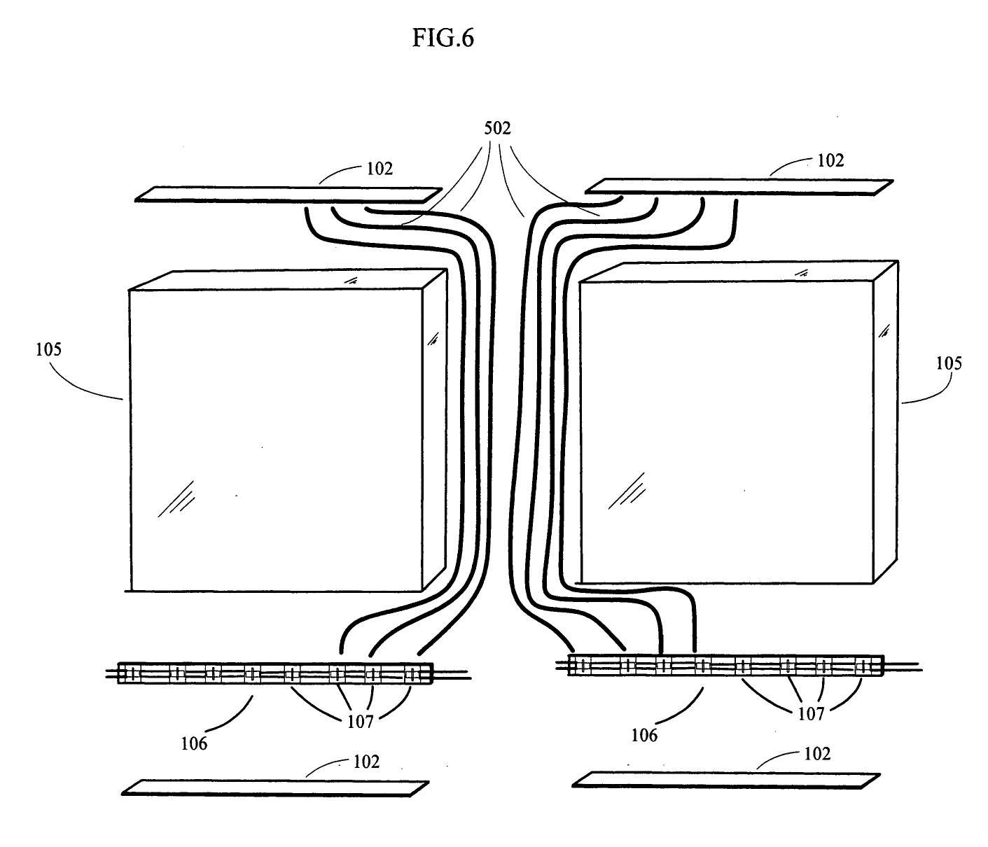

FIG. 6 illustrates another example of a means of distributing illumination form the LED source 107 when utilizing a non light conducting surface material such as ceramic tile 105. By positioning the conducting strands 502 between the juncture of the tiles 105 and against a reflective surface 102 the illumination is further enhanced. When the light is emitted out the sides of the conducting strands the binding agent (not shown) joining the tiles would preferably permit the illumination into the room. For conducting strands where the light is emitted out the ends that would not be important since the illumination would occur along the area of the reflective material. It should be noted that when the surface is composed of material which precludes the passage of light, the enhancing material would be positioned in a manner and direction to compensate for that characteristic. In the previous examples the reflective material on the top and backing could not be directly against the surface. It could be positioned away from the surface. By using an angle or curve, the reflection of the illumination can still be utilized. It should be noted that in this and the previous examples that the number of strands per light source may vary, and that the number, thickness, and shape are for illustrative purposes only.

There exists in current development of organic light emitting diodes, OLED, a flexible newspaper like printing process, an inexpensive efficient light source. A thin layer of an organic compound that glows when an electrical charge is applied, the OLED may serve as an alternate light source when the process is readily and economically available. Combined with the renewable energy source and the phosphorescent aspect which will be discussed, this may serve as a means of applying the energy saving illumination system to surface materials such as the mentioned tile which are composed of materials which are not transparent or translucent. The enhancement of the illumination with the reflection or magnification previously discussed would be applicable with these OLED as the manufacturing costs decrease.

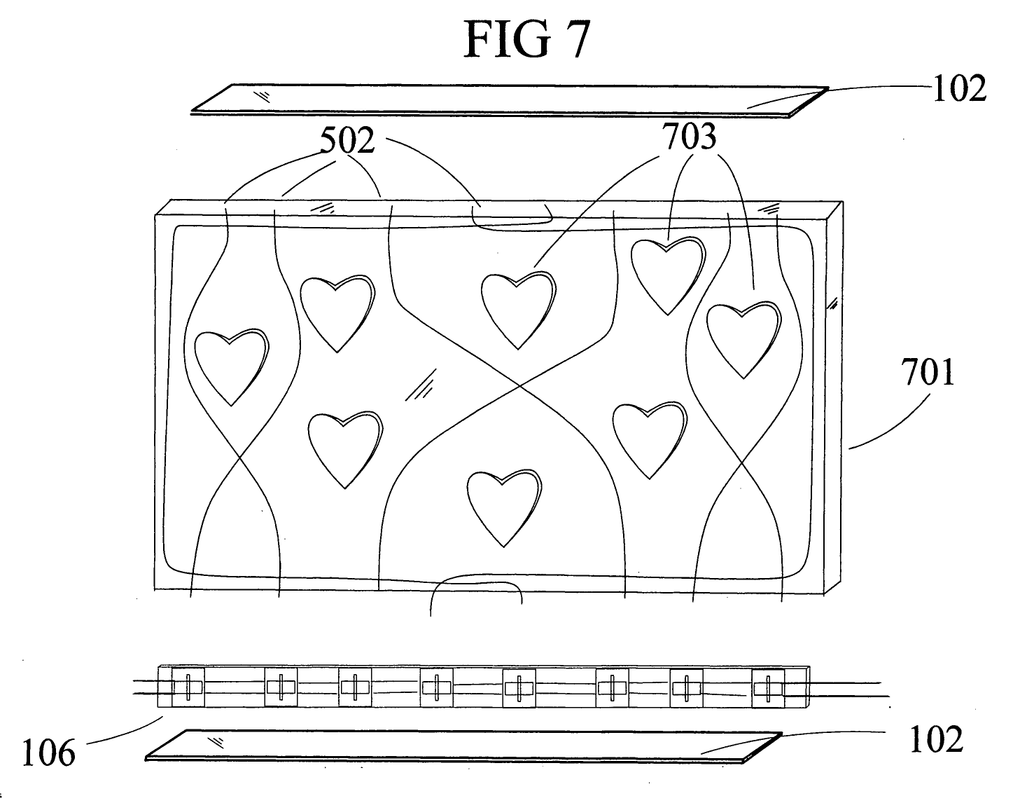

When a decorative object 703 is included within the surface material, the conductive strands 502 may be distributed between the objects as illustrated in FIG. 7. These decorative objects may include interesting shapes such as hearts or flowers, or photographs and or etc. Since they may block some of the reflection from the backing, the conductive strands play a role in the overall illumination for the room. In surfaces which do not transfer light, the conductive strands provide a means of directing the illumination to the enhancement source as in the examples previously mentioned. They would direct the illumination to the reflective material at the back and top of the tile. These conductive strands 502 may be oriented in such a manner as to create an interesting or artistic pattern within the tile 701 so that they may appear as part of the decoration of the tile.

Channels (not shown) within the surface to allow the illumination to pass to the reflective material is another means of conducting the light in opaque material.

As an additional means of creating an appealing ambience, when illumination of different colors is utilized the conductive strand will emit a colored glow. A LED with red green, blue, light in a lamp which can vary the amount of illumination separately being emitted from each color can create a multitude of color variations. This will provide a multitude of illuminated colors to the tile and the room. An illuminator port may be needed to fully utilize the light carrying ability of the conductive strands.

The energy saving illumination system can provide an additional source of illumination, by utilizing a means of providing illumination even after the original source of illumination is turned off. One such means is to utilize a phosphorescent material which when excited by the light source, would continue to emit light after the light source is turned off. Currently phosphorescent powders and paint with non radioactive strontium can produce a phosphorescence glow time of over 8 hours. Because the surface area in the energy saving illumination system is greater than a light bulb, with the phosphorescent materials currently on the market, the glow produced should be sufficient to serve as a means of illuminating a hallway, a doorway, or serve as a night light. This should be more than sufficient to provide illumination during late night hours. when power would ordinarily be turned off. One means of incorporating such material is to utilize it within the composition of the face of the surface. One means is to combine a phosphorescent material to a the structural material such as ceramic clay, resin, plastic, glass etc. Another means is to utilize the phosphorescent material with the binding material. The binding material may incorporate the phosphorescent material preferably in suspension or solution with a hardening agent such as but not limited to resin, plastic, glass and etc. The binding material would incorporate the decorative objects creating a surface such as a mosaic tile. Another means is for the decorative objects to contain the phosphorescent material such that the shape of these decorative objects which create a pleasant glow when the power to the illuminating light source is turned off. Another means is to utilize a phosphorescent paint in a manner and location such that illumination will continue after the power is switched off. Various colors of phosphorescence are currently available on the market.

While a tile is utilized in the discussion, it should be noted that it is exemplary only and many variations are anticipated, for example a shape can be created so that these properties can be utilized to work in conjunction with existing surfaces. The item, such as a half moon molding, can be positioned on top of the existing backsplash in a kitchen or bath. and provide illumination and an appealing look to the existing backsplash. While the discussion described surfaces which where either transparent and translucent or surfaces which did not conduct light. Material exist which appear opaque but once illumination is applied they appear translucent and conducts illumination and color. This is a particularly beneficial when used with the conductive strands which would also provide a pleasant colored glow through the surface.

Replacing the light source if it should fail can be achieved by utilizing a means such as, but not limited to, clips, peel and stick tape, tacky glue, and, or etc to adhere it to the surface or the object that the surface is attached to, as for example a tile to a wall.

In a further effort to save energy, the surface material could be made out of recycled material such as recycled glass. The power would be attached to a motion sensor so the system would be illuminated only when some one enters the room.

In some instances a means of attaching the system to as wall or other surface may be required. For the example of a tile, some means of attaching the tile to the wall would include a peel and stick tape for do-it-yourselfers, grout, glue, clips, screws are just some of the means.

The energy saving system may be utilized in kitchens or bathrooms for counter tops, backsplashes and shower stalls In addition it may be utilized as floor boards, crown molding at ceilings or for door jambs. Floors and ceilings may also take advantage of such a system. These are just some of the potential uses for the energy saving illuminated system.

What is claimed is:

1. An energy saving illumination system comprising:
an energy source, preferably renewable,
an illumination source or plurality thereof,
a surface comprised of a front, back, top, bottom and sides,
a means of enhancing the illumination, preferably requiring no energy,
a means of conducting said illumination thereby illuminating the surface,
a means of additional illumination is provided, preferably without additional commercial energy requirements.

2. An energy saving illumination system of claim 1. wherein the energy source is provided by a renewable means such as solar, wind and.or etc.

3. An energy saving illumination system of claim 2 wherein a means of storing the energy until required is provided.

4. An energy saving illumination system of claim 1. wherein said illumination is enhanced by a non energy requiring means such as, reflection, magnification and/or etc.

5. An energy saving illumination system of claim 1. wherein a means of conducting said illumination is provided by an non energy requiring means such as but not limited to fiber optic cable.

6. An energy saving illumination system in claim 1. Wherein channels provide a means of allowing the illumination to pass through the surface to the enhancement material.

7. An energy illumination system of claim 1 wherein an additional means of illumination is provided by a means not requiring additional commercial energy such as but not limited to phosphorescence.

8. An energy saving illumination system in claim 1. wherein a motion sensor would be utilized to turn on the illumination.
